(19) United States
(12) Patent Application Publication
(10) Pub. No.: US 2012/0328901 A1
(43) Pub. Date: Dec. 27, 2012

(54) HIGH TENSILE STEEL SHEET SUPERIOR IN FORMABILITY AND METHOD OF MANUFACTURING THE SAME

(76) Inventors: Toshiki Nonaka, Tokyo (JP); Naoki Matsutani, Tokyo (JP); Toshio Ogawa, Tokyo (JP); Nobuhiro Fujita, Tokyo (JP)

(21) Appl. No.: 13/521,090

(22) PCT Filed: Jan. 13, 2011
(86) PCT No.: PCT/JP2011/050440

§ 371 Date: Jul. 9, 2012

(30) Foreign Application Priority Data
Jan. 13, 2010 (JP) 2010-004735

(51) Int. Cl. C22C 38/12; C22C 38/28; C22C 38/32; C22C 38/38; B21B 45/04; C22C 38/04; C22C 38/06; C22C 38/14; B32B 15/01; C22C 38/22; C22C 38/02

(52) U.S. Cl. 428/659; 420/83; 420/84; 420/87; 420/103; 72/39

(57) ABSTRACT

With regard to an Al content (%) and a Si content (%), a relation of a formula (A) is established, and an average value Yₐᵥₑ defined by a formula (B) regarding hardnesses measured at 100 points or more with a nanoindenter is equal to or more than 40.

0.3≦0.7×[Si]+[Al]≦1.5 (A)

Yₐᵥₑ=Σ(180×(Xᵢ−3)⁻²/n) (B)

([Al] indicates the Al content (%), [Si] indicates the Si content (%), n indicates a total number of the measuring points of the hardnesses, and Xᵢ indicates the hardness (GPa) at the i-th measuring point (i is a natural number equal to or less than n).

This application is a national stage application of International Application No. PCT/JP2011/050440, filed Jan. 13, 2011, which claims priority to Japanese Application No. 2010-004735, filed Jan. 13, 2010, the content of which is incorporated by reference herein in its entirety.

### TECHNICAL FIELD

The present invention is directed to a high tensile steel sheet superior in a formability suitable for a vehicle body or the like and a method of manufacturing the same.

### BACKGROUND ART

In recent years, weight reduction of a vehicle body is increasingly required for the sake of improvement of automobile fuel efficiency. Though a steel sheet with a high strength is used for weight reduction of the vehicle body, press forming becomes difficult as the strength becomes high. This is because, in general, a yield stress of a steel sheet increases and an elongation is reduced as a strength of the steel sheet becomes high. Further, as a high tensile steel sheet for a vehicle body, one to which a galvanizing treatment or a chemical treatment such as a phosphating treatment is performed, such as a galvanized steel sheet, is sometimes used. Therefore, such a high tensile steel sheet is required also of a good galvanizing property and a chemical treatment property.

With regard to improvement of an elongation, a TRIP (transformation induced plasticity) steel sheet, in which strain induced transformation of a retained austenite is used, is described in Patent Literature 1 and Patent Literature 2. However, since a large amount of C is contained in a TRIP steel sheet, there is a problem in welding such as nugget cracking. Further, in a TRIP steel sheet with a tensile strength equal to or more than 980 MPa in particular, a yield stress is so high that there is a problem that a shape fixability at a time of press forming or the like is low.

Further, there is a concern that a delayed fracture occurs in the high tensile TRIP steel sheet with the tensile strength equal to or more than 980 MPa. Since the TRIP steel sheet contains a large amount of a retained austenite, a void and a dislocation are apt to occur frequently in an interface between a martensite generated by induced transformation at a time of processing and a surrounding phase thereof. Then, hydrogen is accumulated in such places, thereby generating the delayed fracture.

Further, with regard to reduction of a yield stress, DP (dual phase) steel, which includes a ferrite, is described in Patent Literature 3. However, in order to manufacture the DP steel, it is necessary that a cooling speed after recrystallization annealing is as quite high as equal to or more than 30° C./s. Accordingly, application to manufacturing of a galvanized steel sheet using a common manufacturing line is difficult.

Though Patent Literatures 3 to 6 describe various indexes about a formability, it is difficult to make a formability of elongation flanging of an automobile component sufficient by only adjusting those indexes within predetermined ranges.

### CITATION LIST

### Patent Literature

Patent Literature 1: Japanese Laid-open Patent Publication No. 61-157625
Patent Literature 2: Japanese Laid-open Patent Publication No. 10-130776
Patent Literature 3: Japanese Laid-open Patent Publication No. 57-155329
Patent Literature 4: Japanese Laid-open Patent Publication No. 2001-355043
Patent Literature 5: Japanese Laid-open Patent Publication No. 2007-302918
Patent Literature 6: Japanese Laid-open Patent Publication No. 2008-63604

### SUMMARY OF THE INVENTION

### Technical Problem

An object of the present invention is to provide a high tensile steel sheet superior in a formability in which the formability and a galvanizing treatment property can be made compatible with each other, and a method of manufacturing the same.

### Solution to Problem

The present inventors find out that, with regard to a DP steel sheet having a low yield strength, a formability and a galvanizing treatment property may be made compatible with each other by making a relation between a Si content and an Al content appropriate and making a hardness distribution appropriate. Then, the present inventors have reached ideas of embodiments of the invention described below.

(1) A high tensile steel sheet superior in a formability, containing, in mass %:

C: 0.03% to 0.20%;

Si: 0.005% to 1.0%;

Mn: 1.0% to 3.1%; and

Al: 0.005% to 1.2%,

a P content being over 0% and equal to or less than 0.06%,

an S content being over 0% and equal to or less than 0.01%,

an N content being over 0% and equal to or less than 0.01%, and

a balance being composed of Fe and inevitable impurities,

wherein

a metal structure includes a ferrite and a martensite,

a relation of a formula (A) is established about an Al content (%) and a Si content (%), and

an average value Yₐᵥₑ defined by a formula (B) regarding hardnesses measured at 100 points or more with a nanoindenter is equal to or more than 40.

0.3≦0.7×[Si]+[Al]≦1.5 (A)

Yₐᵥₑ=Σ(180×(Xᵢ−3)²/n) (B)

([Al] indicates the Al content (%), [Si] indicates the Si content (%), n indicates a total number of the measuring points of the hardnesses, and Xᵢ indicates the hardness (GPa) at the i-th measuring point (i is a natural number equal to or less than n).

(2) The high tensile steel sheet superior in a formability according to (1), which further contains:

at least one selected from a group consisting of, in mass %,
B: 0.00005% to 0.005%,
Mo: 0.01% to 0.5%,
Cr: 0.01% to 1.0%,
V: 0.01% to 0.1%,
Ti: 0.01% to 0.1%,
Nb: 0.005% to 0.05%,
Ca: 0.0005% to 0.005%, and
REM: 0.0005% to 0.005%.

(3) The high tensile steel sheet superior in a formability according to (1) or (2), wherein the high tensile steel sheet is a cold-rolled steel sheet.

(4) The high tensile steel sheet superior in a formability according to any one of (1) to (3), wherein the high tensile steel sheet is a galvanized steel sheet.

(5) The high tensile steel sheet superior in a formability according to any one of (1) to (4), wherein a martensite fraction in the steel structure is over 5%.

(6) A method of manufacturing a high tensile steel sheet superior in a formability, including:

obtaining a hot-rolled steel strip by performing hot rolling;

next, performing acid pickling of the hot-rolled steel strip;

next, obtaining a cold-rolled steel strip by performing cold rolling of a steel strip with a tandem rolling mill having a plurality of stands;

next, performing continuous annealing of the cold-rolled steel strip in a continuous annealing line; and

next, performing temper rolling of the cold-rolled steel strip,

wherein

the steel strip contains, in mass %:
C: 0.03% to 0.20%;
Si: 0.005% to 1.0%;
Mn: 1.0% to 3.1%; and
Al: 0.005% to 1.2%,
a P content being over 0% and equal to or less than 0.06%,
an S content being over 0% and equal to or less than 0.01%,
an N content being over 0% and equal to or less than 0.01%, and
a balance being composed Fe and an inevitable impurity, and

a relation of a formula (C) being established about a cold-rolling reduction in the first stand among the plurality of stands and a temperature increasing rate in a first heating zone in the continuous annealing line.

50≦r1^{0.85}×V≦300 (C)

(r1 indicates the cold-rolling reduction (%), and V indicates the temperature increasing rate (° C./s).

(7) The method of manufacturing a high tensile steel sheet superior in a formability according to (6), further including, after said performing the continuous annealing:

performing a galvanizing treatment to the cold-rolled steel strip; and

next, performing a temper rolling of the cold-rolled steel strip.

(8) The method of manufacturing a high tensile steel sheet superior in a formability according to (7), further including, after said performing the galvanizing treatment, holding the cold-rolled steel strip at a temperature of 400° C. to 650° C. for t seconds, wherein a relation of a formula (D) is established.

t≦60×[C]+20×[Mn]+24×[Cr]+40×[Mo] (D)

([C] indicates a C content (%), [Mn] indicates an Mn content (%), [Cr] indicates a Cr content (%), and [Mo] indicates an Mo content (%).)

### Advantageous Effects of Invention

According to the present invention, since a relation between an Al content and a Si content are made appropriate and a hardness distribution is made appropriate, a formability and a galvanizing treatment property can be made compatible with each other.

### BRIEF DESCRIPTION OF DRAWINGS

FIG. 1 is a graph representing a relation among an Al content and a Si content, and a formability, and a galvanizing treatment property and a chemical treatment property;

FIG. 2 is a graph representing a relation between an average value Yₐᵥₑ of a formula (B) and a formability;

FIG. 3 is a diagram illustrating a test piece used for a side bend test;

FIG. 4 is a graph representing a relation between a cold-rolling reduction r and a temperature increasing rate V, and a formability; and

FIG. 5 is a graph representing a relation between a C content, a Mn content, a Cr content and an Mo content, and a holding time.

### DESCRIPTION OF EMBODIMENTS

Hereinafter, an embodiment of the present invention will be described in detail with reference to the attached drawings.

A steel sheet according to the embodiment of the present invention contains, in mass %, C: 0.03% to 0.20%, Si: 0.005% to 1.0%, Mn: 1.0% to 3.1%, and Al: 0.005% to 1.2%, a P content being over 0% and equal to or less than 0.06%, an S content being over 0% and equal to or less than 0.01%, an N content being over 0% and equal to or less than 0.01%, and the balance being composed of Fe and an inevitable impurity.

Here, a reason for a limit of the content of such a component will be explained.

C secures a strength and stabilizes a martensite. If a C content is less than 0.03%, it is difficult to obtain a sufficient strength and the martensite is hard to be formed. On the other hand, if the C content is over 0.2%, the strength becomes too high and a sufficient ductility is hard to be obtained and sufficient weldability is hard to be obtained. Therefore, a range of the C content is 0.03% to 0.2%. Here, it is preferable that the C content is equal to or more than 0.06%, and it is more preferable that the C content is equal to or more than 0.07%. Further, it is preferable that the C content is equal to or less than 0.15% and it is more preferable that the C content is equal to or less than 0.12%.

Si secures a strength and a ductility, exhibits a deoxidation effect, and improves a quenching property. If a Si content is less than 0.005%, it is difficult to obtain a sufficient deoxidation effect, and it is difficult to obtain a sufficient quenching property. On the other hand, if the Si content is over 1.0%, it is difficult to obtain a sufficient chemical treatment property and a galvanizing treatment property. Therefore, a range of the Si content is 0.005% to 1.0%. Here, it is preferable that the Si content is equal to or more than 0.01%, and it is more preferable that the Si content is equal to or more than 0.05%. Further, in a case that a good galvanizing treatment property is regarded as important in particular, it is preferable that the Si content is equal to or less than 0.7%. Further, it is more preferable that the Si content is equal to or less than 0.6%, and it is further preferable that the Si content is equal to or less than 0.1%.

Mn secures a strength, delays generation of a carbide, and is effective in generation of a ferrite. If a Mn content is less than 1.0%, it is difficult to obtain a sufficient strength, and generation of the ferrite becomes insufficient, making it hard to obtain a sufficient ductility. On the other hand, if the Mn content is over 3.1%, a quenching property is too high, generating a martensite excessively and the strength is too high. Consequently, a sufficient ductility is hard to be obtained, and a large variation in the property is apt to occur. Therefore, a range of the Mn content is 1.0% to 3.1%. Here, it is preferable that the Mn content is equal to or more than 1.2% and it is more preferable that the Mn content is equal to or more than 1.5%. Further, it is preferable that the Mn content is equal to or less than 2.8% and it is more preferable that the Mn content is equal to or less than 2.6%.

Al accelerates generation of a ferrite, improves a ductility, and exhibits a deoxidation effect. If an Al content is less than 0.005%, it is difficult to obtain a sufficient deoxidation effect. On the other hand, if the Al content is over 1.2%, an inclusion such as alumina increases, and it is hard to obtain a sufficient processability. Therefore, a range of the Al content is 0.005% to 1.2%. Here, it is preferable that the Al content is equal to or more than 0.02% and it is more preferable that the Al content is equal to or more than 0.1%. Further, it is preferable that the Al content is equal to or less than 1.0% and it is more preferable that the Al content is equal to or less than 0.8%. It should be noted that, even if a large amount of Al is contained, a chemical treatment property and a galvanizing treatment property are hard to be reduced.

Since P contributes to improvement of a strength, P may be contained in correspondence with a required strength level. However, if the P content is over 0.06%, segregation in a grain boundary occurs and a local ductility is apt to be reduced, and a weldability is apt to be reduced. Therefore, the P content is equal to or less than 0.06%. Here, it is preferable that the P content is equal to or less than 0.03%, and it is more preferable that the P content is equal to or less than 0.02%. On the other hand, in order to make the P content less than 0.001%, an intensive cost increase in a steel forming stage is necessary, and in order to make the P content 0%, a further intensive cost increase is necessary. Therefore, it is preferable that the P content is over 0% and equal to or more than 0.001%.

S generates MnS and reduces a local ductility and weldability. In particular, if the S content is over 0.01%, these are prominent. Accordingly, the S content is 0.01%. Here, it is preferable that the S content is equal to or less than 0.007%, and it is more preferable that the S content is equal to or less than 0.005%. On the other hand, in order to make the S content less than 0.001%, an intensive cost increase in a steel forming stage is necessary, and in order to make the S content 0%, a further intensive cost increase is necessary. Therefore, it is preferable that the S content is over 0% and equal to or more than 0.001%.

N is inevitably contained, and an N content over 0.01% reduces an aging property. Further, AlN is generated in a large quantity and an effect of Al is reduced. Accordingly, the N content is equal to or less than 0.01%. Here, it is preferable that the N content is equal to or less than 0.007%, and it is more preferable that the N content is equal to or less than 0.005%. On the other hand, in order to make the N content less than 0.0005%, an intensive cost increase in a steel forming stage is necessary, and in order to make the N content 0%, a further intensive cost increase is necessary. Therefore, it is preferable that the N content is over 0% and equal to or more than 0.0005%.

It should be noted that the steel sheet according to the present embodiment may contain one or more selected from a group consisting of B, Mo, Cr, V, Ti, Nb, Ca, and rare earth metals (REM) within a range indicated below.

B contributes to securing of a quenching property, generates BN, and increases effective Al. In general, when a ferrite fraction increases, a superior elongation may be secured, but a layered structure is made and sometimes a local ductility is reduced. B suppresses such reduction of the local ductility. If a B content is less than 0.00005%, the effect is hard to be obtained. On the other hand, if the B content is over 0.005%, an elongation in a tensile test and an elongation distortion amount (value of a fracture elongation distortion) in a side bend test are reduced significantly. Accordingly, it is preferable that a range of the B content is 0.00005% to 0.005%. Here, it is more preferable that the B content is equal to or more than 0.0001%, and it is further preferable that the B content is equal to or more than 0.0005%. Further, it is more preferable that the B content is equal to or less than 0.003%, and it is further preferable that the B content is equal to or less than 0.002%.

Mo contributes to securing of a strength and improvement of a quenching property. If a Mo content is less than 0.01%, these effects are hard to be obtained. On the other hand, if the Mo content is over 0.5%, generation of a ferrite is suppressed, so that a ductility is reduced. Further, if the Mo content is over 0.5%, obtaining a sufficient chemical treatment property and a galvanizing treatment property sometimes becomes difficult. Accordingly, it is preferable that a range of the Mo content is 0.01% to 0.5%. Here, it is more preferable that the Mo content is equal to or more than 0.03%, and it is further preferable that the Mo content is equal to or more than 0.05%. Cr contributes to securing of a strength and improvement of a quenching property. If a Cr content is less than 0.01%, these effects are hard to be obtained. On the other hand, if the Cr content is over 1.0%, generation of a ferrite is suppressed and a ductility is reduced. Further, if the Cr content is over 1.0%, obtaining a sufficient chemical treatment property and a galvanizing treatment property sometimes becomes difficult. Accordingly, it is preferable that a range of the Cr content is 0.01% to 1.0%. Here, it is more preferable that the Cr content is equal to or more than 0.1% and it is further preferable that the Cr content is equal to or more than 0.2%. Further, it is more preferable that the Cr content is equal to or less than 0.7% and it is further preferable that the Cr content is equal to or less than 0.5%.

V, Ti, and Nb contribute to securing of a strength. If a V content is less than 0.01%, a Ti content is less than 0.01%, and an Nb content is less than 0.005%, the effect is hard to be obtained. On the other hand, if the V content is over 0.1%, the Ti content is over 0.1%, and the Nb content is over 0.05%, an elongation in a tensile test and an amount of an elongation distortion in a side bend test are reduced significantly. Accordingly, it is preferable that a range of the V content is 0.01% to 0.1%, and it is preferable that a range of the Ti content is 0.01% to 0.1%, and it is preferable that a range of the Nb content is 0.005% to 0.05%.

Ca and REM contribute to control of an inclusion and improvement of a hole-expanding property. If a Ca content is less than 0.0005% and an REM content is less than 0.0005%, these effects are hard to be obtained. On the other hand, if the Ca content is over 0.005% and the REM content is over 0.005%, an elongation in a tensile test and an amount of an elongation distortion in a side bend test are reduced significantly. Accordingly, it is preferable that a range of the Ca content is 0.0005% to 0.005%, and it is preferable that a range of the REM content is 0.0005% to 0.005%.

Incidentally, as the inevitable impurity, Sn and the like can be cited. If a content of such an inevitable impurity is equal to or less than 0.01%, an effect of the embodiment is not impaired.

In the steel sheet according to the present embodiment, a relation of a formula (A) is established between the Al content and the Si content.

0.3≦0.7×[Si]+[Al]≦1.5 (A)

Here, [Al] indicates the Al content (%) and [Si]indicates the Si content (%).

A large amount of elements are added to conventional high tensile steel, and formation of a ferrite is suppressed. Therefore, a ferrite fraction of a structure is low and a fraction of another phase (second phase) is high. Accordingly, an elongation is considerably reduced particularly in DP steel with a tensile strength equal to or more than 980 MPa. In contrast, it is possible to make an elongation larger by increasing the Si content, by lowering the Mn content, or the like. However, if the Si content is made high, a chemical treatment property and a galvanizing treatment property are apt to be reduced. Further, if the Mn content is made low, securing of a strength becomes difficult.

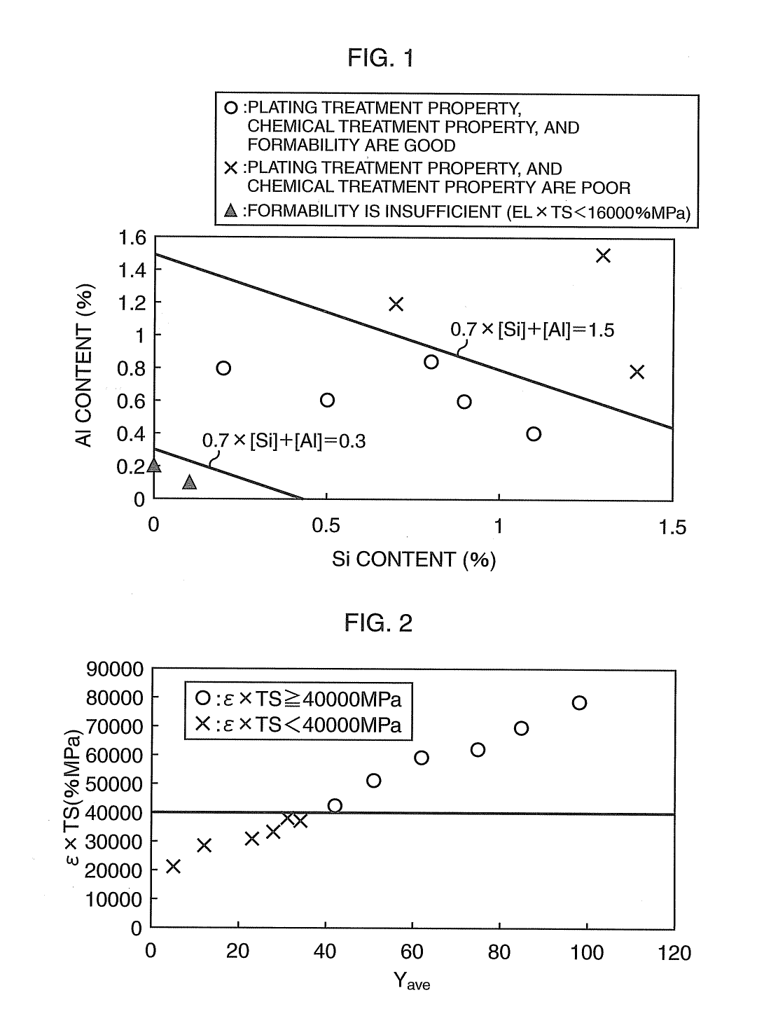

Under the circumstances, the present inventors found out the above-described effect of Al, as a result of earnest study. Further, as a result of investigation of a relation among a Si content and an Al content, a formability, and a galvanizing treatment property (a plating treatment property) and a chemical treatment property, a result represented in FIG. 1 was obtained. In other words, if a value of “0.7×[Si]+[Al]” was less than 0.3, a formability was insufficient. Further, if a value of “0.7×[Si]+[Al]” was over 1.5, a good chemical treatment property and a galvanizing treatment property failed to be obtained. From those results, it may be said that when the relation of the formula (A) is satisfied it is possible to secure a sufficient ferrite fraction thereby to obtain a superior elongation while securing a plating treatment property and a chemical treatment property. Incidentally, a result of an investigation of a relation between a formability and a result of a tensile test indicated that when the formability was sufficient, with regards to an elongation EL (%) and a tensile strength TS (MPa) obtained by the tensile test, a value of “EL×TS” was equal to or more than 16000% MPa and that when the formability was insufficient the value of “EL×TS” was less than 16000% MPa.

It should be noted that an evaluation of the formability and an evaluation of the chemical treatment property and the galvanizing property may be performed similarly to an evaluation, for example, in later-described examples No. 1 to No. 27 and comparative examples No. 28 to No. 43.

Further, a metal structure of the steel sheet according to the present embodiment includes a ferrite and a martensite. The ferrite includes a polygonal ferrite and a bainitic ferrite. The martensite includes a normal martensite obtained by quenching and a martensite obtained by tempering performed to a temperature equal to or lower than 600° C. In the present embodiment, because of such a metal structure, a tensile strength and a ductility may be made compatible with each other.

The ferrite fraction and the martensite fraction are not limited in particular, but it is preferable that the martensite fraction is over 5%. This is because a martensite fraction of less than 5% makes it hard to obtain a tensile strength of equal to or more than 500 MPa. It should be noted that more preferable ranges of the ferrite fraction and the martensite fraction are different in correspondence with required tensile strengths and elongations. In other words, since heightening of the ferrite fraction enables securing of the elongation and heightening of the martensite fraction enables securing of the tensile strength, it is preferable to adjust each range based on a balance of the elongation and the tensile strength. For example, if the tensile strength is 500 MPa to 800 MPa, it is preferable that the range of the ferrite fraction is 50% to 90%, and it is preferable that the range of the martensite fraction is 10% to 40%. If the tensile strength is 800 MPa to 1100 MPa, it is preferable that the range of the ferrite fraction is 20% to 60%, and it is preferable that the range of the martensite fraction is 30% to 60%. If the tensile strength is over 1100 MPa, it is preferable that the ferrite fraction is equal to or less than 30% and it is preferable that the martensite fraction is equal to or more than 40%.

Further, it is preferable that the metal structure of the steel sheet according to the present embodiment also includes a bainite, and it is preferable that a range of a bainite fraction is 10% to 40%. Incidentally, in order to secure a tensile strength, it is more effective to increase the martensite fraction than to increase the bainite fraction, the martensite being able to secure a required tensile strength by smaller fraction. Thus, it becomes possible to increase the ferrite fraction by that portion thereby to increase an elongation. Therefore, it is preferable that the martensite fraction is higher than the bainite fraction. It should be noted that if an austenite remains in a metal structure, a secondary processing brittleness and a delayed fracture property are apt to be reduced. Therefore, it is preferable that a retained austenite is not substantially contained, but the retained austenite of less than 3% may be inevitably contained.

Further, in the steel sheet according to the present embodiment, an average value Yₐᵥₑ defined by a formula (B) regarding hardnesses measured at 100 points or more with a nanoindenter is equal to or more than 40.

Yₐᵥₑ=Σ(180×(Xᵢ−3)⁻²/n) (B)

Here, n indicates a total number of measuring points of hardnesses, and Xᵢ indicates a hardness (GPa) at the i-th (i is a natural number equal to or less than n) measuring point.

The present inventors found out that as an index indicating a formability of a steel sheet used for a vehicle body or the like an elongation distortion amount ε measured in a side bend test is superior to an elongation and a hole-expanding value. Further, the present inventors found out that the larger an elongation distortion amount ε is made the better a formability becomes.

Further, the present inventors found out that as represented in FIG. 2 the larger the average value Yₐᵥₑ of the formula (B) is made the larger a value of “ε×TS” being a product of an elongation distortion amount ε (%) and a tensile strength TS (MPa) becomes. Besides, when the value of “ε×TS” was equal to or more than 40000% MPa, a good formability could be obtained. Hence, it may be said that if an average value Yₐᵥₑ is equal to or more than 40, a good formability may be obtained. It should be noted that an upper limit of the average value Yₐᵥₑ is not limited in particular, but a maximum value of the average value Yₐᵥₑ obtained in the test conducted by the present inventors is 250.

Further, it was also found out that in a case that the value of the product “ε×TS” is equal to or more than 40000% MPa, it is more preferable and superior in terms of a formability if further a value “EL×TS” being a product of the elongation EL (%) and the tensile strength TS (MPa) is equal to or more than 16000% MPa.

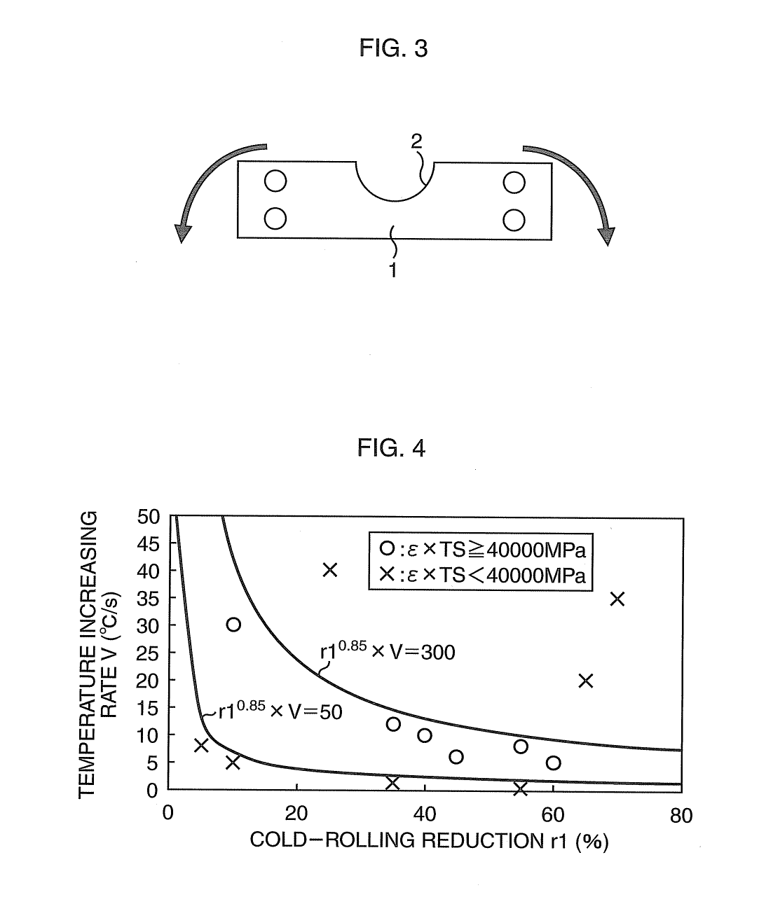

It should be noted that in the side bend test, an in-plane bending is applied to an end face on which a cutout is formed, and an elongation distortion amount at a time that a through crack occurs is measured. FIG. 3 illustrates a shape of a test piece. In order to evaluate an elongation flange property, a cutout 2 with a large curvature radius is provided in the test piece 1. Further, in order to measure an elongation distortion amount after the test, a marking line is provided. Once the test is started, the test piece 1, while receiving a tensile stress in a circumferential direction, is bent and fractured. In the side bend test, it is judged that a “fracture” occurs when a through crack occurs in a thickness direction. In other words, unlikely to in the hole-expanding test, the elongation distortion after the through crack is not influenced by a size of a crack. Hence, variation of crack judgment does not occur.

According to the present embodiment, since the relation between the Si content and the Al content represented by the formula (A) is made appropriate and a hardness distribution represented by the formula (B) is made appropriate, the formability, and the galvanizing treatment property and the chemical treatment property may be made compatible with each other.

Further, the hardness distribution represented by the formula (B) reflects a result of the side bend test, and the result of the side bend test may represent a formability of an automobile part or the like with a higher degree of accuracy than an elongation and a hole-expanding property being conventional indexes representing a formability.

It should be noted that though a strength of the steel sheet according to the present embodiment is not limited in particular, but a tensile strength of, for example, about 590 MPa to 1500 MPa may be obtained in correspondence with a composition. An effect of compatibility of the formability, and the galvanizing treatment property and the chemical treatment property is prominent particularly in a high tensile steel sheet of equal to or more than 980 MPa.

In order to manufacture the steel sheet according to the present embodiment described above, a steel with the above-described composition may be used, and a processing similar to that of, for example, a method of manufacturing a hot-rolled steel sheet, a method of manufacturing a cold-rolled steel sheet, or a method of manufacturing a plated steel sheet which are generally performed may be performed. For example, obtaining of a cold-rolled steel strip by cold rolling of a steel strip, and continuous annealing of the cold-rolled steel strip may be performed. Further, there may be performed obtaining of a hot-rolled steel strip by hot rolling of steel, acid pickling of the hot-rolled steel strip, obtaining of a cold-rolled steel strip by cold rolling of the hot-rolled steel strip, continuous annealing of the cold-rolled steel strip, and temper rolling of the cold-rolled steel strip, in that sequence. Further, it is possible to perform a galvanizing treatment after continuous annealing. In such a case, for example, the temper rolling may be performed after the galvanizing treatment.

For example, hot rolling may be performed under a general condition. Incidentally, in order to prevent reduction of processability as a result that a strain is excessively applied to a ferrite grain, it is preferable to perform hot rolling at a temperature equal to or more than a point Aᵣ₃. Further, if hot rolling is performed at a temperature over 940° C., a recrystallized grain diameter after annealing sometimes become coarse excessively. Accordingly, it is preferable that hot rolling is performed at equal to or less than 940° C. The higher a coiling temperature of hot rolling is, the more recrystallization and grain growth are accelerated, so that processability is improved. However, if the coiling temperature is over 550° C., generation of a scale occurring at a time of hot rolling is accelerated. Thus, a time necessary for acid pickling is sometimes prolonged. Further, a ferrite and a pearlite are generated in layers, so that C is apt to diffuse. Accordingly, it is preferable that the coiling temperature is equal to or less than 550° C. On the other hand, if the coiling temperature is less than 400° C., a steel sheet is hardened and a load at a time of cold rolling becomes high. Accordingly, it is preferable that the coiling temperature is equal to or more than 400° C.

Acid pickling may be performed under a general condition.

Cold rolling after acid pickling may also be performed under a general condition. It should be noted that it is preferable that a range of a rolling reduction of cold rolling is 30% to 70%. It is because if the rolling reduction is less than 30%, correction of a shape of a steel sheet sometimes becomes difficult, and if the rolling reduction is over 70%, a crack occurs in an edge portion of the steel sheet or a deviation of the shape occurs.

Further, it is preferable that cold rolling is performed continuously with a tandem rolling mill having a plurality of stands and that a cold rolling reduction r1 (%) in the first stand and a temperature increasing rate V (° C./Sec) in a first heating zone in a continuous annealing line satisfy a relation of a formula (C). Here, the continuous annealing line includes a continuous annealing line provided in a manufacturing line of a cold-rolled steel sheet and a continuous annealing line provided in a manufacturing line of a continuous galvanized steel sheet.

50≦r1^{0.85}×V≦300 (C)

As a result that the present inventors investigated the relation between the cold rolling reduction r1 and the temperature increasing rate V, a result represented in FIG. 4 was obtained. As described above, if the value of “ε×TS” is equal to or more than 40000% MPa, a good formability may be obtained. Thus, in FIG. 4, a condition under which the value of “ε×TS” is equal to or more than 40000% MPa is indicated by “◯” while a condition under which the value of “ε×TS” is less than 40000% MPa is indicated by “X”. If the value of “r1^{0.85}×V” is less than 50, a ferrite becomes too soft and a hardness difference from a hard phase is large. On the other hand, if the value of “r1^{0.85}×V” is over 300, a rate of unrecrystallization is too high and a formability is reduced. It should be noted that it is more preferable that the value of “r1^{0.85}×V” is equal to or more than 100 and that it is more preferable that the value of “r1^{0.85}×V” is equal to or less than 250.

It is preferable that continuous annealing is performed in a range equal to or more than a point A_{c1} and equal to or less than a point A_{c3}+100° C. If continuous annealing is performed at a temperature less than the point A_{c1}, a structure is apt to become uneven. On the other hand, if continuous annealing is performed at a temperature over the point A_{c3}+100° C., generation of a ferrite is suppressed by coarsening of an austenite, leading to reduction of an elongation. Further, it is desirable that the annealing temperature is equal to or lower than 900° C. from an economical viewpoint. With regard to an annealing time, it is preferable that the temperature is held for equal to or more than 30 seconds in order to eliminate a layered structure. On the other hand, if the temperature is held for over 30 minutes, an effect is saturated and a productivity is reduced. Accordingly, it is preferable that a range of the annealing time is 30 seconds to 30 minutes.

In cooling of continuous annealing, it is preferable that a finish temperature is equal to or less than 600° C. If the finish temperature is over 600° C., an austenite is apt to remain and a secondary processing brittleness and a delayed fracture property are apt to be reduced.

It should be noted that a tempering treatment at equal to or less than 600° C. may be performed after continuous annealing. By performing such a tempering treatment, for example, a hole-expanding property and a brittleness can be made better.

The present inventors consider, when performing a galvanizing treatment after continuous annealing, that it is preferable that after the galvanizing treatment the cold-rolled steel strip is held at a temperature of 400° C. to 650° C. for a time (t second) satisfying a relation of a formula (D).

t≦60×[C]+20×[Mn]+24×[Cr]+40×[Mo] (D)

Here, [C] indicates a C content (%), [Mn] indicates a Mn content (%), [Cr] indicates a Cr content (%), and [Mo] indicates a Mo content (%).

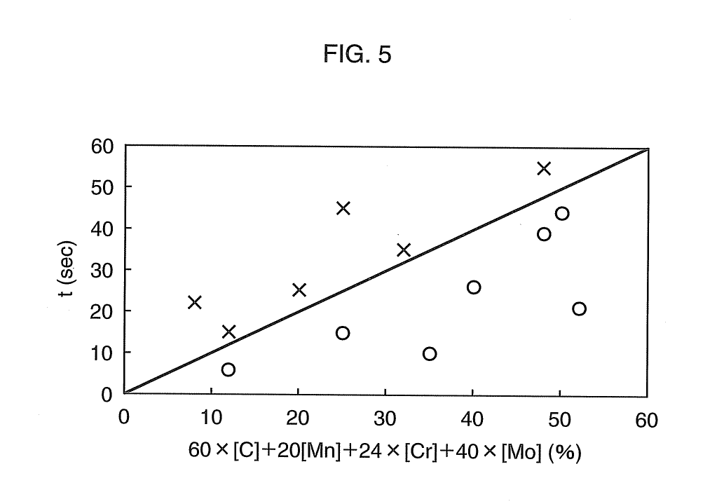

The present inventors, as a result of investigating a holding time in holding the cold-rolled steel strip at a temperature of 400° C. to 650° C. after the galvanizing treatment, obtained a result represented in FIG. 5. A mark ◯ in FIG. 5 indicates that a sufficient tensile strength was obtained and a mark X indicates that the tensile strength was comparatively low. As represented in FIG. 5, if a value of the holding time t (s) was over a value of a right side (mass %) of the formula (D), the tensile strength was comparatively low. This is because a bainite is generated excessively thereby to make it difficult to secure a sufficient martensite fraction.

### Example

Next, an experiment conducted by the present inventors will be explained.

First, steel of examples No. 1 to No. 34 and of comparative examples No. 35 to No. 52 having compositions represented in a table 1 was fabricated with a vacuum melting furnace. Next, after the steel was cooled and solidified, the steel was reheated to 1200° C. and finish rolling of hot rolling was performed at 880° C. Thereafter, the steel was cooled to 500° C., and a temperature was held at 500° C. for one hour, thereby a hot-rolled steel plate was obtained. Holding of the temperature at 500° C. for one hour simulates a heat treatment at a time of coiling in hot rolling. Subsequently, a scale was removed from the hot-rolled steel plate by acid pickling, and thereafter, cold rolling was performed at a cold-rolling reduction r represented in a table 4, thereby a cold-rolled steel plate was obtained. Next, with a continuous annealing simulator, the temperature of the cold-rolled steel plate was increased at a temperature increasing rate V represented in the table 4 and annealing was performed at 770° C. for 60 seconds. Thereafter, galvanizing was performed and an alloying treatment was performed in an alloying furnace, thereby an alloyed galvanized steel sheet was manufactured.

Then, an elongation EL (%) and a tensile strength TS (MPa) were measured in a tensile test, and an elongation distortion amount ε (%) was measured in a side bend test. In the tensile test, a JIS 5 test piece was used. The side bend test was performed according to a procedure described above. Then, a value of “EL×TS” and a value of “ε×TS” were found. Results thereof are represented in a table 2. If at least the value of “ε×TS” is equal to or more than 40000% MPa, it may be said that the tensile strength and a ductility are compatible with each other, and if the value of “EL×TS” is equal to or more than 16000% MPa, it may be said that the tensile strength and the ductility are better.

Further, a metal structure was observed with an optical microscope. On this occasion a ferrite was observed after nital etching, and a martensite was observed after repeller etching. Then, a ferrite fraction and a martensite fraction were calculated. Further, a surface having been chemically polished to be ¼ thickness from a surface layer of the steel sheet was subjected to X-ray diffraction and a retained austenite fraction was calculated. Results thereof are represented in the table 2.

Further, hardnesses X₁ to X₃₀₀ were measured at 300 points per a test piece with a nanoindenter. On this occasion, as the nanoindenter, “TRIBOINDENTER” of HYSITRON was used and a measuring interval was 3 p.m. Then, an average value Yₐᵥₑ was calculated from the hardnesses X₁ to X₃₀₀. A result thereof is represented in a table 3.

Further, evaluations of the chemical treatment property and the galvanizing treatment property were also performed. In the evaluation of the chemical treatment property, after a treatment with phosphate treatment chemicals according to a standard specification, an aspect of a chemical coating was observed by visual observation and by a scanning electron microscope. Then, one which covered a steel sheet base densely was judged to be good and one which did not was judged to be poor. As the phosphate treatment chemicals, “Bt3080” of Nihon Parkerizing Co., Ltd. being common automotive chemicals was used. In the evaluation of the galvanizing treatment property, after annealing was performed under a condition satisfying the formula (C), a galvanizing treatment was performed with a galvanizing simulator and visual observation was done. Then, one in which a plating film was evenly formed in an area equal to or more than 90% of a plated surface was judged to be good and one in which the plating film was not evenly formed was judged to be poor. Then, one which was good in both the evaluation of the chemical treatment property and the evaluation of the galvanizing treatment property is indicated as “◯”, and one which was poor in at least one of the above is indicated as “X” in the table 3. Further, after the galvanizing treatment, a temperature was held at 500° C. for a time indicated in a table 4.

TABLE 1

| | | Composition (%) | | | | | | | | | | | | | | |
|---|---|---|---|---|---|---|---|---|---|---|---|---|---|---|---|---|
| | No. | C | Si | Mn | P | S | N | Al | Cr | Mo | V | Ti | Nb | Ca | B | REM |
| Example | 1 | 0.035 | 0.125 | 1.65 | 0.005 | 0.008 | 0.0035 | 0.625 | — | — | — | — | — | — | — | — |
| | 2 | 0.041 | 0.199 | 2.02 | 0.023 | 0.006 | 0.0064 | 0.712 | — | — | — | — | — | — | — | — |
| | 3 | 0.049 | 0.188 | 2.50 | 0.008 | 0.009 | 0.0055 | 0.512 | — | 0.15 | — | — | — | — | — | — |
| | 4 | 0.061 | 0.421 | 1.12 | 0.007 | 0.007 | 0.0035 | 0.444 | — | — | — | — | — | — | — | — |
| | 5 | 0.052 | 0.058 | 1.40 | 0.008 | 0.008 | 0.0033 | 0.526 | 0.210 | 0.11 | — | — | — | — | — | — |
| | 6 | 0.111 | 0.180 | 1.69 | 0.006 | 0.009 | 0.0087 | 0.964 | — | — | — | — | — | 0.004 | — | — |
| | 7 | 0.125 | 0.056 | 1.05 | 0.032 | 0.005 | 0.0042 | 0.632 | — | 0.15 | — | — | — | — | — | — |
| | 8 | 0.079 | 0.256 | 1.21 | 0.044 | 0.001 | 0.0040 | 0.712 | 0.320 | 0.05 | — | — | — | 0.003 | — | — |
| | 9 | 0.095 | 0.125 | 1.23 | 0.008 | 0.002 | 0.0065 | 0.235 | — | — | — | — | — | — | — | — |
| | 10 | 0.077 | 0.245 | 1.34 | 0.007 | 0.009 | 0.0022 | 0.321 | — | 0.25 | — | — | — | — | — | — |
| | 11 | 0.091 | 0.321 | 1.18 | 0.006 | 0.007 | 0.0015 | 0.954 | — | 0.11 | — | — | — | — | — | — |
| | 12 | 0.095 | 0.624 | 2.09 | 0.012 | 0.006 | 0.0035 | 0.788 | — | 0.21 | — | — | — | — | — | — |
| | 13 | 0.105 | 0.215 | 1.11 | 0.011 | 0.005 | 0.0022 | 0.623 | 0.510 | — | — | — | — | — | — | — |
| | 14 | 0.101 | 0.088 | 2.68 | 0.009 | 0.008 | 0.0035 | 0.421 | — | 0.23 | — | — | — | — | 0.0015 | — |
| | 15 | 0.165 | 0.231 | 1.02 | 0.023 | 0.007 | 0.0034 | 0.388 | — | — | — | — | — | — | — | — |
| | 16 | 0.069 | 0.566 | 2.99 | 0.005 | 0.001 | 0.0024 | 0.954 | — | 0.05 | — | — | — | — | — | — |
| | 17 | 0.125 | 0.215 | 1.15 | 0.011 | 0.003 | 0.0037 | 0.812 | — | 0.11 | — | — | 0.01 | — | 0.0010 | — |
| | 18 | 0.111 | 0.199 | 2.03 | 0.016 | 0.004 | 0.0041 | 0.323 | — | — | — | — | 0.03 | — | — | — |
| | 19 | 0.132 | 0.256 | 1.93 | 0.013 | 0.007 | 0.0034 | 0.965 | — | 0.12 | — | — | — | — | — | 0.0020 |
| | 20 | 0.140 | 0.689 | 2.95 | 0.018 | 0.003 | 0.0025 | 0.223 | — | 0.21 | — | 0.03 | — | — | — | — |
| | 21 | 0.132 | 0.115 | 2.41 | 0.016 | 0.003 | 0.0064 | 0.652 | — | — | — | — | — | — | 0.0008 | — |
| | 22 | 0.144 | 0.215 | 2.19 | 0.014 | 0.005 | 0.0007 | 0.238 | — | — | — | — | — | 0.002 | — | — |
| | 23 | 0.125 | 0.264 | 1.54 | 0.013 | 0.003 | 0.0087 | 0.333 | 0.150 | 0.11 | — | 0.05 | — | — | — | — |
| | 24 | 0.126 | 0.184 | 2.35 | 0.022 | 0.007 | 0.0090 | 0.612 | — | — | — | — | — | — | 0.0015 | — |
| | 25 | 0.115 | 0.230 | 2.50 | 0.004 | 0.003 | 0.0040 | 0.321 | — | — | 0.02 | — | — | — | — | — |
| | 26 | 0.108 | 0.311 | 2.45 | 0.005 | 0.003 | 0.0035 | 0.120 | 0.350 | — | — | — | — | — | 0.0007 | — |
| | 27 | 0.085 | 0.120 | 2.25 | 0.004 | 0.003 | 0.0034 | 0.250 | — | 0.055 | — | — | 0.01 | — | — | — |
| | 28 | 0.082 | 0.250 | 2.15 | 0.007 | 0.004 | 0.0033 | 0.680 | — | — | — | — | — | — | — | — |
| | 29 | 0.095 | 0.450 | 2.55 | 0.007 | 0.005 | 0.0035 | 0.520 | — | — | — | — | — | — | — | — |
| | 30 | 0.173 | 0.862 | 1.24 | 0.050 | 0.008 | 0.0069 | 0.512 | — | 0.15 | 0.03 | — | — | — | — | — |
| | 31 | 0.182 | 0.098 | 2.02 | 0.041 | 0.005 | 0.0065 | 0.678 | — | 0.22 | — | — | — | — | — | — |
| | 32 | 0.192 | 0.154 | 2.37 | 0.038 | 0.003 | 0.0034 | 0.369 | — | 0.31 | — | — | 0.02 | — | — | — |
| | 33 | 0.072 | 0.521 | 2.65 | 0.005 | 0.001 | 0.0024 | 0.872 | — | — | — | — | — | — | — | — |
| | 34 | 0.118 | 0.205 | 2.01 | 0.011 | 0.003 | 0.0037 | 0.625 | — | 0.12 | — | — | — | — | — | — |
| Comparative | 35 | 0.010 | 0.235 | 1.11 | 0.007 | 0.008 | 0.0035 | 1.178 | — | — | — | — | — | — | — | — |
| example | 36 | 0.315 | 0.125 | 2.15 | 0.003 | 0.006 | 0.0007 | 0.512 | — | — | — | — | — | — | — | — |
| | 37 | 0.135 | 1.523 | 2.35 | 0.007 | 0.009 | 0.0035 | 0.765 | — | 0.15 | — | — | — | — | 0.0006 | — |
| | 38 | 0.116 | 1.498 | 0.09 | 0.009 | 0.003 | 0.0032 | 0.621 | 0.280 | 0.32 | — | — | — | — | — | — |
| | 39 | 0.132 | 0.235 | 3.25 | 0.009 | 0.004 | 0.0034 | 0.678 | — | — | — | — | — | — | — | — |
| | 40 | 0.124 | 0.321 | 2.12 | 0.075 | 0.003 | 0.0021 | 0.325 | 0.300 | 0.16 | — | — | 0.01 | — | — | — |
| | 41 | 0.062 | 0.125 | 2.50 | 0.002 | 0.020 | 0.0059 | 0.412 | 0.150 | — | — | — | — | — | — | — |
| | 42 | 0.035 | 0.145 | 1.15 | 0.011 | 0.010 | 0.0210 | 0.253 | — | — | — | — | 0.02 | — | — | — |
| | 43 | 0.195 | 0.165 | 1.95 | 0.018 | 0.004 | 0.0093 | 0.003 | — | 0.15 | — | — | — | — | — | — |
| | 44 | 0.193 | 0.210 | 2.65 | 0.005 | 0.003 | 0.0022 | 1.923 | — | 0.22 | — | — | — | — | — | — |
| | 45 | 0.078 | 0.120 | 2.10 | 0.008 | 0.003 | 0.0021 | 0.150 | — | — | — | — | — | — | — | — |
| | 46 | 0.142 | 0.920 | 2.35 | 0.008 | 0.003 | 0.0021 | 1.150 | — | 0.35 | — | 0.11 | — | — | — | — |
| | 47 | 0.110 | 0.350 | 2.06 | 0.056 | 0.003 | 0.0021 | 0.250 | — | 0.11 | — | — | — | 0.002 | — | — |
| | 48 | 0.078 | 0.520 | 1.55 | 0.046 | 0.002 | 0.0029 | 0.110 | — | 0.12 | — | — | — | — | — | — |
| | 49 | 0.130 | 0.915 | 2.39 | 0.051 | 0.006 | 0.0034 | 0.842 | — | 0.02 | — | — | 0.01 | — | — | — |
| | 50 | 0.121 | 0.120 | 1.25 | 0.005 | 0.003 | 0.0030 | 0.700 | 0.210 | 0.03 | — | — | — | — | 0.0010 | — |
| | 51 | 0.085 | 0.745 | 2.12 | 0.051 | 0.006 | 0.0034 | 0.040 | — | 0.01 | — | 0.10 | — | — | — | — |
| | 52 | 0.105 | 0.244 | 1.54 | 0.005 | 0.003 | 0.0030 | 0.241 | 0.050 | — | 0.10 | — | — | — | 0.0010 | — |

TABLE 2

| | | | | | | | Ferrite | Bainite | Martensite | Retained |
|---|---|---|---|---|---|---|---|---|---|---|
| | No. | Ts (MPa) | EL (%) | ε (%) | EL × TS | ε × TS | fraction | fraction | fraction | austenite fraction |
| Example | 1 | 577 | 33.2 | 86 | 19156.4 | 49622 | 68 | 8 | 22 | 2.0 |
| | 2 | 576 | 32.5 | 82 | 18720 | 47232 | 68 | 6 | 23 | 2.7 |
| | 3 | 585 | 31.2 | 78 | 18252 | 45630 | 69 | 7 | 22 | 2.1 |
| | 4 | 622 | 29.5 | 69 | 18349 | 42918 | 65 | 8 | 25 | 1.8 |
| | 5 | 612 | 29.8 | 71 | 18237.6 | 43452 | 64 | 8 | 26 | 2.4 |
| | 6 | 635 | 29.4 | 86 | 18669 | 54610 | 59 | 6 | 33 | 1.9 |
| | 7 | 622 | 30.1 | 68 | 18722.2 | 42296 | 58 | 9 | 31 | 2.2 |
| | 8 | 638 | 28.5 | 71 | 18183 | 45298 | 59 | 10 | 30 | 1.0 |
| | 9 | 652 | 28.1 | 69 | 18321.1 | 44988 | 55 | 12 | 31 | 2.2 |
| | 10 | 685 | 27.2 | 62 | 18632 | 42470 | 52 | 16 | 31 | 1.0 |
| | 11 | 734 | 26.4 | 58 | 19377.6 | 42572 | 52 | 10 | 36 | 2.3 |
| | 12 | 795 | 24.5 | 88 | 19477.5 | 69960 | 52 | 16 | 32 | 0.0 |
| | 13 | 789 | 24.2 | 55 | 19093.8 | 43395 | 51 | 12 | 35 | 2.2 |
| | 14 | 825 | 22.2 | 49 | 18315 | 40425 | 50 | 13 | 34 | 2.7 |
| | 15 | 788 | 23.5 | 56 | 18518 | 44128 | 52 | 10 | 36 | 2.1 |
| | 16 | 853 | 21.5 | 52 | 18339.5 | 44356 | 55 | 5 | 38 | 2.0 |
| | 17 | 832 | 22.4 | 66 | 18636.8 | 54912 | 52 | 6 | 41 | 1.5 |
| | 18 | 874 | 21.2 | 51 | 18528.8 | 44574 | 51 | 11 | 36 | 2.3 |
| | 19 | 873 | 20.1 | 61 | 17547.3 | 53253 | 48 | 12 | 38 | 2.2 |
| | 20 | 953 | 19.2 | 46 | 18297.6 | 43838 | 44 | 14 | 41 | 1.5 |
| | 21 | 987 | 18.5 | 43 | 18259.5 | 42441 | 42 | 14 | 42 | 2.3 |
| | 22 | 981 | 17.2 | 48 | 16873.2 | 47088 | 37 | 17 | 44 | 2.0 |
| | 23 | 988 | 16.5 | 62 | 16302 | 61256 | 36 | 18 | 46 | 0.0 |
| | 24 | 993 | 18.3 | 56 | 18171.9 | 55608 | 41 | 18 | 41 | 0.0 |
| | 25 | 1005 | 16.5 | 52 | 16582.5 | 52260 | 42 | 24 | 32 | 2.5 |
| | 26 | 1015 | 16.8 | 49 | 17052 | 49735 | 40 | 28 | 30 | 1.8 |
| | 27 | 1018 | 17.2 | 51 | 17509.6 | 51918 | 43 | 25 | 30 | 2.3 |
| | 28 | 1023 | 16.5 | 55 | 16879.5 | 56265 | 40 | 27 | 31 | 2.2 |
| | 29 | 1035 | 17.4 | 48 | 18009 | 49680 | 39 | 24 | 35 | 2.1 |
| | 30 | 1252 | 13.5 | 42 | 16902 | 52584 | 38 | 14 | 48 | 0.0 |
| | 31 | 1356 | 12.3 | 39 | 16678.8 | 52884 | 15 | 23 | 62 | 0.0 |
| | 32 | 1512 | 11.3 | 33 | 17085.6 | 49896 | 12 | 13 | 75 | 0.0 |
| | 33 | 998 | 16.9 | 42 | 16866.2 | 41916 | 42 | 18 | 38 | 2.0 |
| | 34 | 1012 | 16.5 | 41 | 16698 | 41492 | 40 | 18 | 41 | 1.5 |
| Comparative | 35 | 335 | 33.2 | 65 | 11122 | 21775 | 92 | 6 | 0 | 1.9 |
| example | 36 | 1623 | 9.2 | 21 | 14931.6 | 34083 | 5 | 3 | 90 | 2.5 |
| | 37 | 985 | 19.5 | 59 | 19207.5 | 58115 | 44 | 13 | 42 | 1.0 |
| | 38 | 885 | 22.3 | 62 | 19735.5 | 54870 | 55 | 12 | 32 | 1.0 |
| | 39 | 1235 | 10.2 | 25 | 12597 | 30875 | 30 | 18 | 52 | 0.0 |
| | 40 | 795 | 20.1 | 31 | 15979.5 | 24645 | 51 | 12 | 37 | 0.0 |
| | 41 | 587 | 26.5 | 42 | 15555.5 | 24654 | 68 | 9 | 21 | 1.8 |
| | 42 | 557 | 28.4 | 52 | 15818.8 | 28964 | 69 | 8 | 21 | 2.1 |
| | 43 | 1470 | 7.1 | 27 | 10437 | 39690 | 21 | 10 | 68 | 1.0 |
| | 44 | 1480 | 11.2 | 45 | 16576 | 66600 | 22 | 9 | 69 | 0.0 |
| | 45 | 880 | 16.5 | 45 | 14520 | 39600 | 25 | 9 | 65 | 1.5 |
| | 46 | 990 | 17.2 | 52 | 17028 | 51480 | 72 | 15 | 11 | 2.1 |
| | 47 | 1010 | 17.5 | 32 | 17675 | 32320 | 42 | 28 | 30 | 0.0 |
| | 48 | 750 | 23.2 | 35 | 17400 | 26250 | 52 | 10 | 36 | 2.5 |
| | 49 | 899 | 10.2 | 42 | 9169.8 | 37758 | 48 | 14 | 38 | 0.0 |
| | 50 | 984 | 13.2 | 40 | 12988.8 | 39360 | 45 | 11 | 42 | 2.3 |
| | 51 | 602 | 26.4 | 42 | 15892.8 | 25284 | 62 | 25 | 12 | 1.2 |
| | 52 | 778 | 19.5 | 40 | 15171 | 31120 | 41 | 32 | 25 | 2.3 |

TABLE 3

| | | | Inequality in | Inequality in | Evaluation of chemical | | |
|---|---|---|---|---|---|---|---|
| | | 0.7 × [Si] + | left side of | right side of | treatment property and | | Evaluation |
| | No. | [Al] | formula (A) | formula (A) | galvanizing treatment property | Yₐᵥₑ | of Yₐᵥₑ |
| Example | 1 | 0.71 | ◯ | ◯ | ◯ | 62 | ◯ |
| | 2 | 0.85 | ◯ | ◯ | ◯ | 52 | ◯ |
| | 3 | 0.64 | ◯ | ◯ | ◯ | 46 | ◯ |
| | 4 | 0.74 | ◯ | ◯ | ◯ | 72 | ◯ |
| | 5 | 0.57 | ◯ | ◯ | ◯ | 61 | ◯ |
| | 6 | 1.09 | ◯ | ◯ | ◯ | 59 | ◯ |
| | 7 | 0.67 | ◯ | ◯ | ◯ | 88 | ◯ |
| | 8 | 0.89 | ◯ | ◯ | ◯ | 56 | ◯ |
| | 9 | 0.32 | ◯ | ◯ | ◯ | 59 | ◯ |
| | 10 | 0.49 | ◯ | ◯ | ◯ | 74 | ◯ |
| | 11 | 1.18 | ◯ | ◯ | ◯ | 64 | ◯ |
| | 12 | 1.22 | ◯ | ◯ | ◯ | 89 | ◯ |
| | 13 | 0.77 | ◯ | ◯ | ◯ | 91 | ◯ |
| | 14 | 0.48 | ◯ | ◯ | ◯ | 64 | ◯ |
| | 15 | 0.53 | ◯ | ◯ | ◯ | 87 | ◯ |
| | 16 | 1.35 | ◯ | ◯ | ◯ | 102 | ◯ |
| | 17 | 0.96 | ◯ | ◯ | ◯ | 54 | ◯ |
| | 18 | 0.46 | ◯ | ◯ | ◯ | 63 | ◯ |
| | 19 | 1.14 | ◯ | ◯ | ◯ | 71 | ◯ |
| | 20 | 0.71 | ◯ | ◯ | ◯ | 56 | ◯ |
| | 21 | 0.73 | ◯ | ◯ | ◯ | 64 | ◯ |
| | 22 | 0.39 | ◯ | ◯ | ◯ | 68 | ◯ |
| | 23 | 0.52 | ◯ | ◯ | ◯ | 74 | ◯ |
| | 24 | 0.74 | ◯ | ◯ | ◯ | 56 | ◯ |
| | 25 | 0.48 | ◯ | ◯ | ◯ | 56 | ◯ |
| | 26 | 0.34 | ◯ | ◯ | ◯ | 49 | ◯ |
| | 27 | 0.33 | ◯ | ◯ | ◯ | 65 | ◯ |
| | 28 | 0.86 | ◯ | ◯ | ◯ | 67 | ◯ |
| | 29 | 0.84 | ◯ | ◯ | ◯ | 71 | ◯ |
| | 30 | 1.12 | ◯ | ◯ | ◯ | 86 | ◯ |
| | 31 | 0.75 | ◯ | ◯ | ◯ | 99 | ◯ |
| | 32 | 0.48 | ◯ | ◯ | ◯ | 62 | ◯ |
| | 33 | 1.24 | ◯ | ◯ | ◯ | 62 | ◯ |
| | 34 | 0.77 | ◯ | ◯ | ◯ | 63 | ◯ |
| Comparative | 35 | 1.34 | ◯ | ◯ | ◯ | 54 | ◯ |
| example | 36 | 0.60 | ◯ | ◯ | ◯ | 56 | ◯ |
| | 37 | 1.83 | ◯ | X | X | 62 | ◯ |
| | 38 | 1.67 | ◯ | X | X | 68 | ◯ |
| | 39 | 0.84 | ◯ | ◯ | ◯ | 74 | ◯ |
| | 40 | 0.55 | ◯ | ◯ | ◯ | 53 | ◯ |
| | 41 | 0.50 | ◯ | ◯ | ◯ | 64 | ◯ |
| | 42 | 0.35 | ◯ | ◯ | ◯ | 59 | ◯ |
| | 43 | 0.12 | ◯ | ◯ | ◯ | 64 | ◯ |
| | 44 | 2.07 | ◯ | X | X | 61 | ◯ |
| | 45 | 0.23 | X | ◯ | X | 62 | ◯ |
| | 46 | 1.79 | ◯ | X | X | 54 | ◯ |
| | 47 | 0.50 | ◯ | ◯ | ◯ | 32 | X |
| | 48 | 0.47 | ◯ | ◯ | ◯ | 21 | X |
| | 49 | 1.48 | ◯ | ◯ | ◯ | 75 | ◯ |
| | 50 | 0.78 | ◯ | ◯ | ◯ | 62 | ◯ |
| | 51 | 0.56 | ◯ | ◯ | ◯ | 75 | ◯ |
| | 52 | 0.41 | ◯ | ◯ | ◯ | 62 | ◯ |

TABLE 4

| | | | | | Inequality in | Inequality in | | | Establishment/non- |
|---|---|---|---|---|---|---|---|---|---|
| | | | | | left side of | right side of | | Right side of | establishment of |
| | No. | r1 (%) | V (° C./s) | r1^{0.85} × V | formula (C) | formula (C) | t (sec) | formula (D) | formula (D) |
| Example | 1 | 22 | 5 | 69 | ◯ | ◯ | 30 | 35 | ◯ |
| | 2 | 30 | 4 | 72 | ◯ | ◯ | 42 | 43 | ◯ |
| | 3 | 24 | 8 | 119 | ◯ | ◯ | 32 | 59 | ◯ |
| | 4 | 14 | 12 | 113 | ◯ | ◯ | 24 | 26 | ◯ |
| | 5 | 20 | 5 | 64 | ◯ | ◯ | 38 | 41 | ◯ |
| | 6 | 27 | 7 | 115 | ◯ | ◯ | 40 | 40 | ◯ |
| | 7 | 21 | 8 | 106 | ◯ | ◯ | 26 | 35 | ◯ |
| | 8 | 24 | 4 | 60 | ◯ | ◯ | 25 | 39 | ◯ |
| | 9 | 24 | 3 | 45 | ◯ | ◯ | 28 | 30 | ◯ |
| | 10 | 30 | 2 | 36 | ◯ | ◯ | 34 | 41 | ◯ |
| | 11 | 18 | 8 | 93 | ◯ | ◯ | 20 | 33 | ◯ |
| | 12 | 20 | 9 | 115 | ◯ | ◯ | 30 | 56 | ◯ |
| | 13 | 12 | 15 | 124 | ◯ | ◯ | 40 | 41 | ◯ |
| | 14 | 11 | 12 | 92 | ◯ | ◯ | 55 | 69 | ◯ |
| | 15 | 14 | 14 | 132 | ◯ | ◯ | 18 | 30 | ◯ |
| | 16 | 14 | 5 | 47 | ◯ | ◯ | 40 | 66 | ◯ |
| | 17 | 19 | 6 | 73 | ◯ | ◯ | 20 | 35 | ◯ |
| | 18 | 20 | 7 | 89 | ◯ | ◯ | 30 | 47 | ◯ |
| | 19 | 22 | 8 | 111 | ◯ | ◯ | 35 | 51 | ◯ |
| | 20 | 22 | 9 | 125 | ◯ | ◯ | 40 | 76 | ◯ |
| | 21 | 17 | 6 | 67 | ◯ | ◯ | 40 | 56 | ◯ |
| | 22 | 24 | 7 | 104 | ◯ | ◯ | 29 | 52 | ◯ |
| | 23 | 16 | 12 | 127 | ◯ | ◯ | 36 | 46 | ◯ |
| | 24 | 14 | 5 | 47 | ◯ | ◯ | 42 | 55 | ◯ |
| | 25 | 21 | 10 | 133 | ◯ | ◯ | 41 | 57 | ◯ |
| | 26 | 25 | 12 | 185 | ◯ | ◯ | 32 | 64 | ◯ |
| | 27 | 14 | 10 | 94 | ◯ | ◯ | 30 | 52 | ◯ |
| | 28 | 16 | 6 | 63 | ◯ | ◯ | 32 | 48 | ◯ |
| | 29 | 13 | 8 | 71 | ◯ | ◯ | 31 | 57 | ◯ |
| | 30 | 16 | 6 | 63 | ◯ | ◯ | 35 | 41 | ◯ |
| | 31 | 13 | 8 | 71 | ◯ | ◯ | 46 | 60 | ◯ |
| | 32 | 11 | 17 | 131 | ◯ | ◯ | 40 | 71 | ◯ |
| | 33 | 20 | 5 | 64 | ◯ | ◯ | 72 | 57 | X |
| | 34 | 19 | 10 | 122 | ◯ | ◯ | 75 | 52 | X |
| Comparative | 35 | 19 | 10 | 122 | ◯ | ◯ | 22 | 23 | ◯ |
| example | 36 | 27 | 4 | 66 | ◯ | ◯ | 35 | 62 | ◯ |
| | 37 | 26 | 6 | 96 | ◯ | ◯ | 42 | 61 | ◯ |
| | 38 | 21 | 9 | 120 | ◯ | ◯ | 20 | 28 | ◯ |
| | 39 | 16 | 8 | 84 | ◯ | ◯ | 40 | 73 | ◯ |
| | 40 | 24 | 5 | 74 | ◯ | ◯ | 44 | 63 | ◯ |
| | 41 | 20 | 5 | 64 | ◯ | ◯ | 30 | 57 | ◯ |
| | 42 | 25 | 4 | 62 | ◯ | ◯ | 20 | 25 | ◯ |
| | 43 | 12 | 15 | 124 | ◯ | ◯ | 30 | 57 | ◯ |
| | 44 | 13 | 12 | 106 | ◯ | ◯ | 40 | 73 | ◯ |
| | 45 | 22 | 8 | 111 | ◯ | ◯ | 30 | 47 | ◯ |
| | 46 | 18 | 5 | 58 | ◯ | ◯ | 40 | 70 | ◯ |
| | 47 | 10 | 3 | 21 | X | ◯ | 30 | 52 | ◯ |
| | 48 | 14 | 2 | 19 | X | ◯ | 32 | 40 | ◯ |
| | 49 | 22 | 25 | 346 | ◯ | X | 45 | 56 | ◯ |
| | 50 | 29 | 15 | 263 | ◯ | X | 30 | 39 | ◯ |
| | 51 | 22 | 5 | 69 | ◯ | X | 62 | 48 | X |
| | 52 | 29 | 10 | 175 | ◯ | X | 75 | 38 | X |

As is recognized from the results represented in the table 1 to the table 4, in the examples No. 1 to No. 34, good galvanizing property and chemical treatment property were obtained, and further, a high tensile strength and a good formability were obtained. In other words, the strength and the ductility were compatible with each other. In particular, in the examples No. 1 to No. 32 satisfying the formula (D), the value of “EL×TS” and the value of “ε×TS” were higher than in the examples No. 33 and No. 34.

On the other hand, in the comparative examples No. 35, 36 and No. 39 to No. 43, in which a component of the steel was out of a range of the present invention, the value of “EL×TS” was less than 16000% MPa, the value of “ε×TS” was less than 40000% MPa, and the formability and the tensile strength were not made compatible with each other. Further, in the comparative examples No. 37, No. 38 and No. 44, in which a component of the steel was out of the range of the present invention, the galvanizing property and the chemical treatment property were low.

In the comparative example 45, which did not satisfy the formula (A), the value of “EL×TS” was less than 16000% MPa, the value of “ε×TS” was less than 40000% MPa, and the formability and the tensile strength were not made compatible with each other, and the galvanizing property and the chemical treatment property were also low. Further, in the comparative example No. 46, which did not satisfy the formula (A), the galvanizing property and the chemical treatment property were low.

In the comparative examples No. 47 and No. 48, which did not satisfy the formula (B) nor the formula (C), the value of “ε×TS” was less than 40000% MPa, and the formability and the tensile strength were not made compatible with each other.

In the comparative examples No. 49 and No. 50, which did not satisfy the formula (C), the value of “EL×TS” was less than 16000% MPa and the value of “ε×TS” was less than 40000% MPa, and the formability and the tensile strength were not made compatible with each other.

In the comparative examples No. 51 and No. 52, which did not satisfy the formula (D), the value of “EL×TS” was less than 16000% MPa and the value of “ε×TS” was less than 40000% MPa, and the formability and the tensile strength were not be made compatible with each other.

### INDUSTRIAL APPLICABILITY

The present invention may be used in, for example, an industry related to a high tensile steel sheet superior in a formability which is used for a vehicle body.

1. A high tensile steel sheet superior in a formability, containing, in mass %:
C: 0.03% to 0.20%;
Si: 0.005% to 1.0%;
Mn: 1.0% to 3.1%; and
Al: 0.005% to 1.2%,
a P content being over 0% and equal to or less than 0.06%,
an S content being over 0% and equal to or less than 0.01%,
an N content being over 0% and equal to or less than 0.01%, and
a balance being composed of Fe and inevitable impurities,
wherein
a metal structure comprises a ferrite and a martensite,
a relation of a formula (A) is established about an Al content (%) and a Si content (%), and
an average value Yₐᵥₑ defined by a formula (B) regarding hardnesses measured at 100 points or more with a nanoindenter is equal to or more than 40.
0.3≦0.7×[Si]+[Al]≦1.5 (A)
Yₐᵥₑ=Σ(180×(Xᵢ−3)⁻²/n) (B)
wherein [Al] indicates the Al content (%), [Si] indicates the Si content (%), n indicates a total number of the measuring points of the hardnesses, and Xᵢ indicates the hardness (GPa) at the i-th measuring point, where i is a natural number equal to or less than n.

2. The high tensile steel sheet superior in a formability according to claim 1, further contains:
at least one selected from a group consisting of, in mass %,
B: 0.00005% to 0.005%,
Mo: 0.01% to 0.5%,
Cr: 0.01% to 1.0%,
V: 0.01% to 0.1%,
Ti: 0.01% to 0.1%,
Nb: 0.005% to 0.05%,
Ca: 0.0005% to 0.005%, and
REM: 0.0005% to 0.005%.

3. The high tensile steel sheet superior in a formability according to claim 1, wherein the high tensile steel sheet is a cold-rolled steel sheet.

4. The high tensile steel sheet superior in a formability according to claim 1, wherein the high tensile steel sheet is a galvanized steel sheet.

5. The high tensile steel sheet superior in a formability according to claim 1, wherein a martensite fraction in the steel structure is over 5%.

6. A method of manufacturing a high tensile steel sheet superior in a formability, comprising:
obtaining a hot-rolled steel strip by performing hot rolling;
next, performing acid pickling of the hot-rolled steel strip;
next, obtaining a cold-rolled steel strip by performing cold rolling of the hot-rolled steel strip with a tandem rolling mill having a plurality of stands;
next, performing continuous annealing of the cold-rolled steel strip in a continuous annealing line; and
next, performing temper rolling of the cold-rolled steel strip,
wherein
the steel strip contains, in mass %:
C: 0.03% to 0.20%;
Si: 0.005% to 1.0%;
Mn: 1.0% to 3.1%; and
Al: 0.005% to 1.2%,
a P content being over 0% and equal to or less than 0.06%,
an S content being over 0% and equal to or less than 0.01%,
an N content being over 0% and equal to or less than 0.01%, and
a balance being composed Fe and an inevitable impurity,
a relation of a formula (A) is established about an Al content (%) and a Si content (%),
a relation of a formula (C) being established about a cold-rolling reduction in the first stand among the plurality of stands and a temperature increasing rate in a first heating zone in the continuous annealing line
0.3≦0.7×[Si]+[Al]≦1.5 (A)
50≦r1^{0.85}×V≦300 (C)
wherein r1 indicates the cold-rolling reduction (%), and V indicates the temperature increasing rate (° C./s).

7. The method of manufacturing a high tensile steel sheet superior in a formability according to claim 6, further comprising, after said performing the continuous annealing:
performing a galvanizing treatment to the cold-rolled steel strip; and
next, performing a temper rolling of the cold-rolled steel strip.

8. The method of manufacturing a high tensile steel sheet superior in a formability according to claim 7, further comprising, after said performing the galvanizing treatment, holding the cold-rolled steel strip at a temperature of 400° C. to 650° C. for t seconds, wherein a relation of a formula (D) is established,
t≦60×[C]+20×[Mn]+24×[Cr]+40×[Mo] (D)
wherein [C] indicates a C content (%), [Mn] indicates an Mn content (%), [Cr] indicates a Cr content (%), and [Mo] indicates an Mo content (%).

9. The high tensile steel sheet superior in a formability according to claim 2, wherein the high tensile steel sheet is a cold-rolled steel sheet.

10. The high tensile steel sheet superior in a formability according to claim 2, wherein the high tensile steel sheet is a galvanized steel sheet.

11. The high tensile steel sheet superior in a formability according to claim 3, wherein the high tensile steel sheet is a galvanized steel sheet.

12. The high tensile steel sheet superior in a formability according to claim 9, wherein the high tensile steel sheet is a galvanized steel sheet.

13. The high tensile steel sheet superior in a formability according to claim 2, wherein a martensite fraction in the steel structure is over 5%.

14. The high tensile steel sheet superior in a formability according to claim 3, wherein a martensite fraction in the steel structure is over 5%.

15. The high tensile steel sheet superior in a formability according to claim 4, wherein a martensite fraction in the steel structure is over 5%.

16. The high tensile steel sheet superior in a formability according to claim 9, wherein a martensite fraction in the steel structure is over 5%.

17. The high tensile steel sheet superior in a formability according to claim 10, wherein a martensite fraction in the steel structure is over 5%.

18. The high tensile steel sheet superior in a formability according to claim 11, wherein a martensite fraction in the steel structure is over 5%.

19. The high tensile steel sheet superior in a formability according to claim 12, wherein a martensite fraction in the steel structure is over 5%.
